(19) United States
(12) Patent Application Publication
(10) Pub. No.: US 2026/0315844 A1
(43) Pub. Date: Oct. 15, 2026

(54) UTILIZING A FIRE MONITOR ADAPTOR

(71) Applicant: Howe & Howe Inc., Waterboro, ME (US)

(72) Inventors: Timothy Merlin Foley, Lyman, ME (US); Jesse Morrill, Standish, ME (US)

(21) Appl. No.: 19/464,022

(22) Filed: Jan. 29, 2026

Related U.S. Application Data
(60) Provisional application No. 63/757,987, filed on Feb. 13, 2025.

(51) Int. Cl. A62C 27/00; A62C 31/05; A62C 37/08

(52) U.S. Cl. CPC A62C 27/00; A62C 31/05; A62C 37/08

(57) ABSTRACT

Techniques involve utilization of a fire monitor adaptor. For example, in the context of a robotic firefighting vehicle, the vehicle may be configured by coupling the fire monitor adaptor with a fluid manifold of the robotic firefighting vehicle. The fire monitor adaptor may include an input section constructed and arranged to couple with the fluid manifold, multiple output sections constructed and arranged to couple with multiple fire monitors, and an intermediate section interconnected between the input section and the multiple output sections, the intermediate section being constructed and arranged to convey fluid from the input section to the multiple output sections. Additionally, the vehicle may be further configured by coupling a first fire monitor with a first output section of the fire monitor adaptor, and coupling a second fire monitor with a second output section of the fire monitor adaptor.

### CROSS REFERENCE TO RELATED APPLICATIONS

This application is a regular utility application based on earlier-filed U.S. Application No. 63/757,987 filed on Feb. 13, 2025, entitled "Utilizing a Fire Monitor Adaptor", the contents and teachings of which are hereby incorporated by reference in their entirety.

### TECHNICAL FIELD

This disclosure relates generally to firefighting apparatus, and more particularly to utilizing a fire monitor adaptor on firefighting equipment such as a firefighting robotic vehicle.

### BACKGROUND

A conventional firefighting robotic vehicle has a vehicle backend which connects to a water source (e.g., to one or more hydrants), and a vehicle frontend which supports a fire monitor. The firefighting robotic vehicle further includes internal plumbing which extends from the vehicle backend to the vehicle frontend through a mid-portion of the vehicle to convey water from the water source to the fire monitor.

During firefighting robotic vehicle operation, a human operator uses a remote controller from a safe distance to robotically drive the vehicle toward a burning target while the vehicle backend is connected to the water source. The human operator then uses the remote controller to robotically aim the fire monitor at the burning target and discharge water from the fire monitor to extinguish the fire.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a firefighting robotic vehicle equipped with an adaptor to utilize multiple fire monitors in accordance with one or more embodiments.

FIG. 2 is an exploded view of the firefighting robotic vehicle in accordance with one or more embodiments.

FIG. 3 is a side view of the firefighting robotic vehicle in accordance with one or more embodiments.

FIG. 4 is a front view of the firefighting robotic vehicle in accordance with one or more embodiments.

FIG. 5 is an elevated side view of the firefighting robotic vehicle in accordance with one or more embodiments.

FIG. 6 is an elevated front view of the firefighting robotic vehicle in accordance with one or more embodiments.

FIG. 7 is a perspective view of a firefighting assembly in accordance with one or more embodiments.

FIG. 8 is a front view of the firefighting assembly in accordance with one or more embodiments.

FIG. 9 is an exploded view of the firefighting assembly in accordance with one or more embodiments.

FIG. 10 is a flowchart of an example procedure which enables an installer to configure a robotic firefighting vehicle with an adaptor to utilize multiple fire monitors in accordance with one or more embodiments.

### DETAILED DESCRIPTION

A conventional firefighting robotic vehicle, which is equipped with a fire monitor, is able to provide water from a water source to a burning target through the fire monitor. However, there may be situations that this conventional firefighting robotic vehicle cannot effectively address.

For example, suppose there is fire covering a wide area or suppose that there are two independent fires. Unfortunately, at best, the conventional firefighting robotic vehicle, which is equipped with a fire monitor, is able to effectively address one burning section of the wide area or one independent fire at a time. Along these lines, while the conventional firefighting robotic vehicle aims the fire monitor to address one burning section or one independent fire, another burning section or another independent fire will be allowed to continue burning, spread/advance, rekindle, and so on. Moreover, precious time and resources may be lost while re-aiming the fire monitor among different targets.

As another example, suppose the conventional firefighting robotic vehicle requires water protection to avoid damage. Unfortunately, the position of the fire monitor may be poorly suited for applying water onto the vehicle to prevent fire/heat damage. Along these lines, the fire monitor may mount to the internal plumbing of the vehicle at a relatively low position on the vehicle frontend and thus be blocked out from spraying vital portions of the vehicle (e.g., blocked from effective self-spraying). Moreover, even if the fire monitor were aimed upward in an attempt to deliver water on top of the vehicle, such upward aiming of the fire monitor may prevent the fire monitor from effectively applying water to the fire at hand.

Alternatively, suppose that a network of water sprayers is installed on top of the firefighting robotic vehicle to spray water on to the vehicle. Unfortunately, such a water sprayer network would add deficiencies such as increase complexity by requiring the vehicle’s internal plumbing to be modified to supply water to the water sprayer network, potentially intruding or interfering with other equipment on top of the vehicle, being unusable for applying water to a burning target at a distance, and so on.

Accordingly, a conventional firefighting robotic vehicle which is equipped with a fire monitor may be unable to effectively address certain situations such as fire covering a wide area or two independent fires, or adequately protecting the vehicle. Moreover, adding a water sprayer network would add complexity/interference and would not be able to address a burning target at a distance. What is needed, therefore, is a way to enable a firefighting vehicle to effectively address multiple targets.

The above need is addressed at least in part by a fire monitor adaptor which supports multiple fire monitors. For example, such a fire monitor adaptor may couple between a firefighting vehicle’s fluid manifold and multiple fire monitors to enable the fluid manifold to supply fluid to the multiple fire monitors. Along these lines, one fire monitor can be directed in a manner that protects the firefighting vehicle while another other fire monitor focuses on a burning target. Accordingly, there is no need for a water sprayer network that would otherwise increase plumbing complexity, potentially intrude or interfere with other equipment on the vehicle, be unusable for applying water to a burning target at a distance, and so on. Rather, the fire monitor adaptor may easily couple with the same fluid manifold that would normally support a single fire monitor and thus alleviate having to modify the vehicle’s internal plumbing.

Moreover, if the firefighting vehicle does not require fire monitor protection, one fire monitor may direct fluid from the fire monitor adaptor toward a first burning target while another fire monitor may direct fluid from the fire monitor adaptor toward a second burning target (e.g., to provide wider coverage of a burning area, to address two independent fires, to increase capacity to a single burning target, etc.). Accordingly, the fire monitor adaptor offers great flexibility to the firefighting vehicle such as enabling the firefighting vehicle to effectively address multiple targets.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

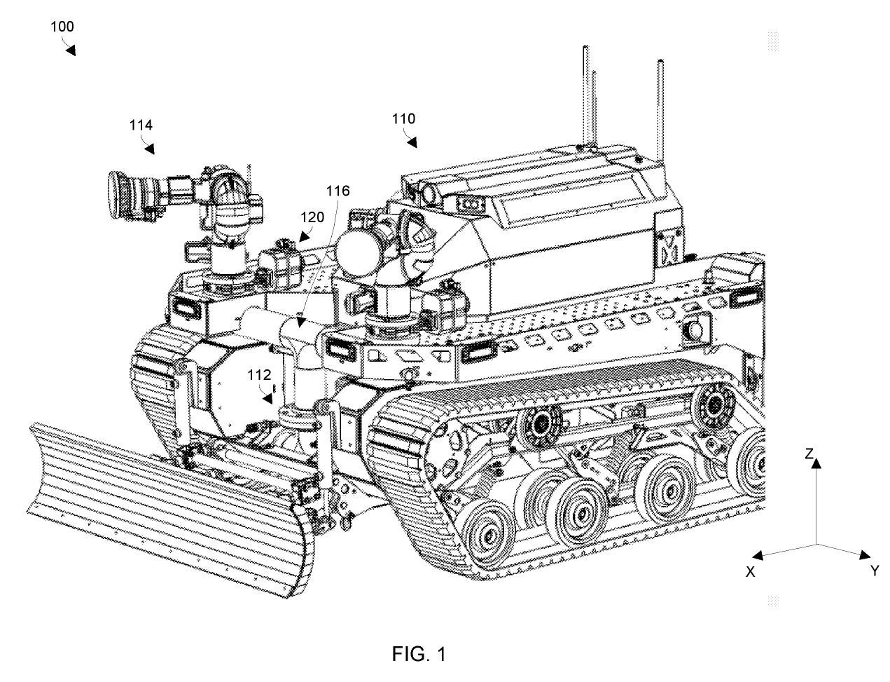

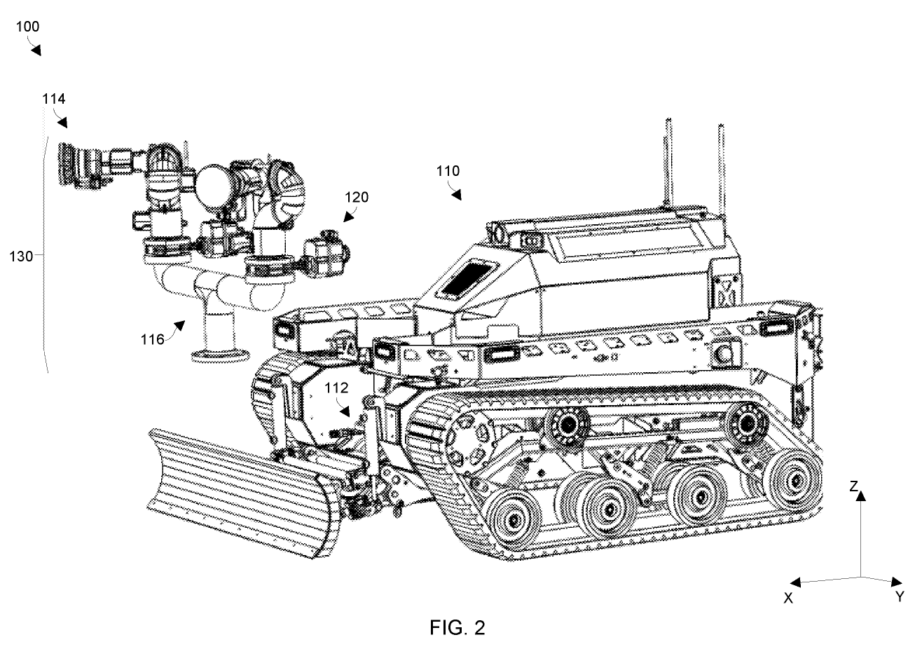

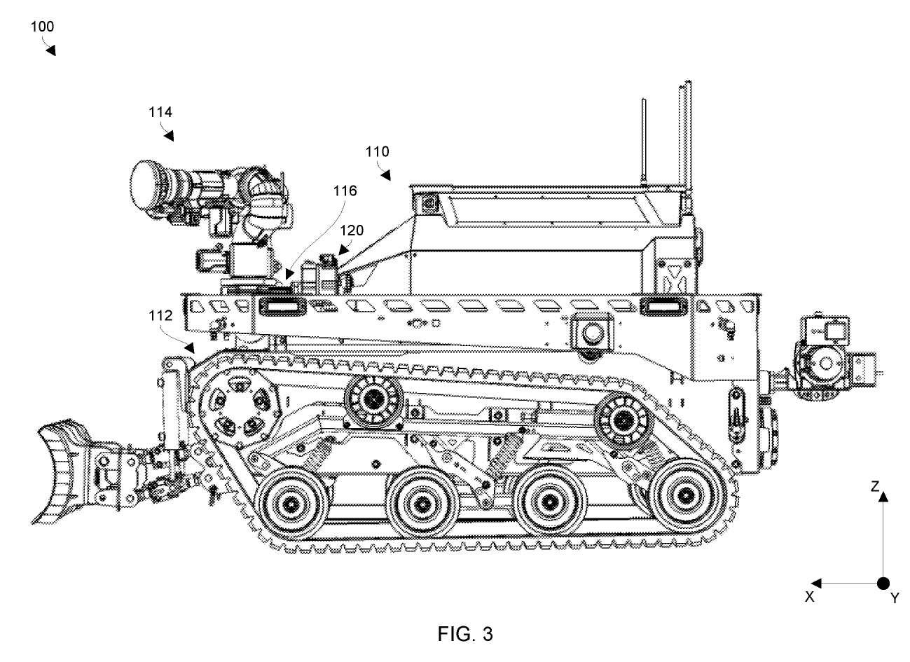

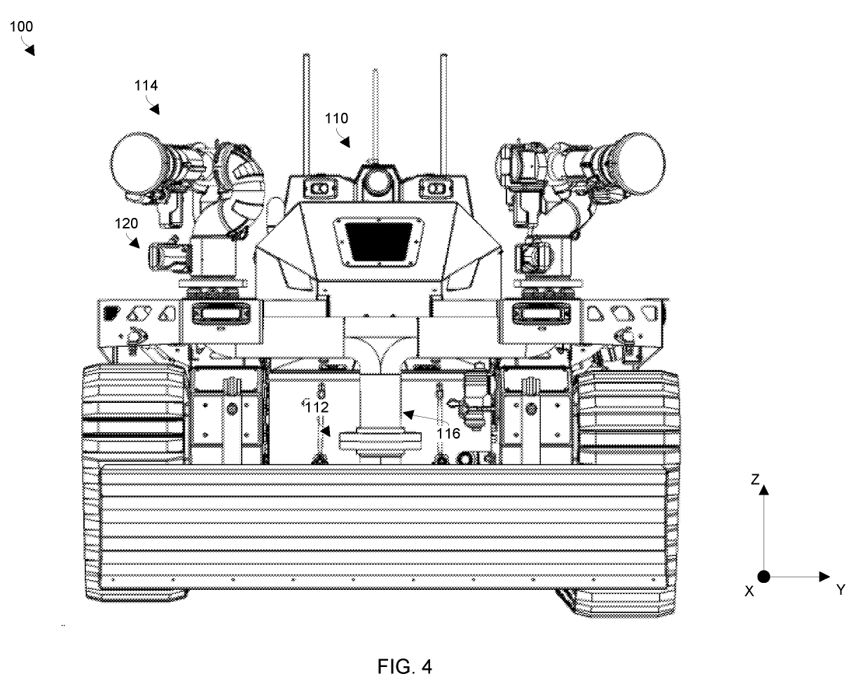

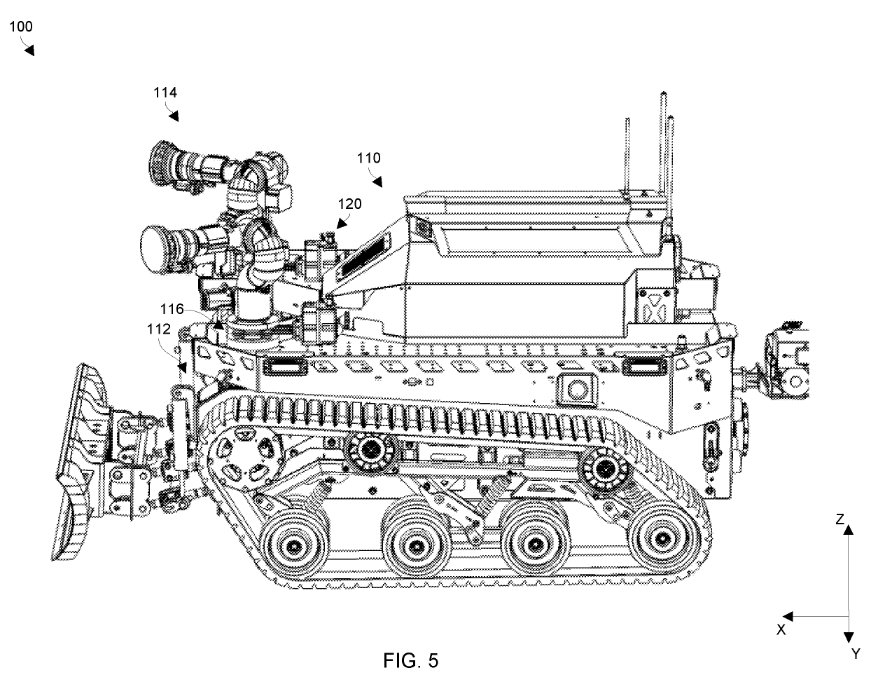

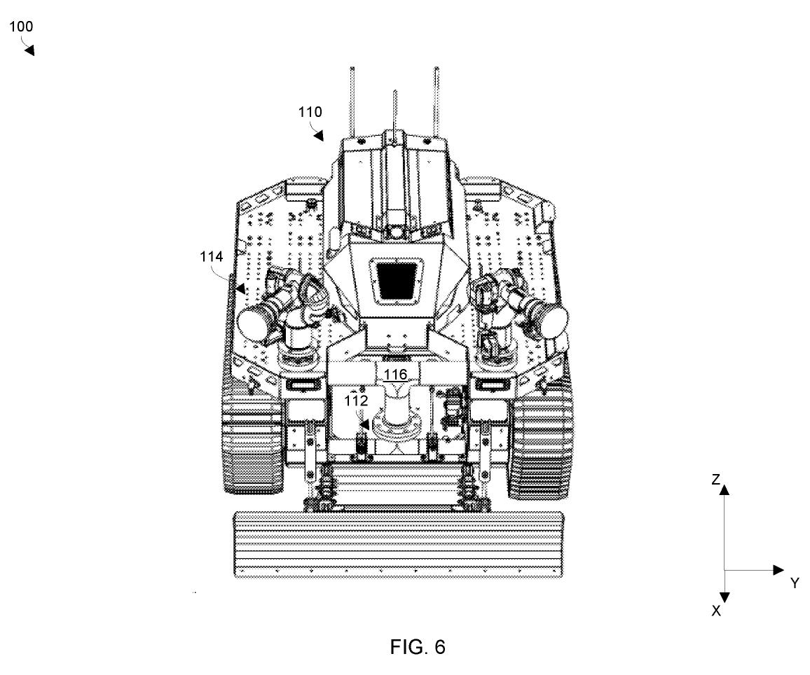

FIGS. 1 through 6 show a firefighting robotic vehicle 100 in accordance with one or more embodiments. FIG. 1 is a perspective view of the firefighting robotic vehicle 100. FIG. 2 is an exploded view of the firefighting robotic vehicle 100. FIG. 3 is a side view of the firefighting robotic vehicle 100. FIG. 4 is a front view of the firefighting robotic vehicle 100. FIG. 5 is an elevated side view of the firefighting robotic vehicle 100. FIG. 6 is an elevated front view of the firefighting robotic vehicle 100.

As shown in FIGS. 1 through 6, the firefighting robotic vehicle 100 includes a robotic firefighting vehicle body 110, a fluid manifold 112, multiple fire monitors 114, and a fire monitor adaptor 116.

The robotic firefighting vehicle body 110 is constructed and arranged to serve as a mobile firefighting platform which can be operated remotely (e.g., from a safe distance via a wireless controller). Such a platform may support a variety of firefighting equipment (e.g., fluid delivery mechanisms, foam concentrate tanks, cameras, sensors, lights, plows, winches, combinations thereof, etc.) and enable a human to utilize such equipment to perform firefighting operations from a safe distance.

Along these lines, the robotic firefighting vehicle body 110 may include a propulsion system (e.g., a set of engines, fuel tanks/batteries, ground engaging members, combinations thereof, etc.) to maneuver the firefighting robotic vehicle 100 within various environments, a wireless communications system, electronic controllers, and so on.

The fluid manifold 112 is supported by the robotic firefighting vehicle body 110 and is constructed and arranged to serve as a fluid supply to the multiple fire monitors 114. Along these lines, one end of the fluid manifold 112 couples with a set of hoses which conveys fluid from a fluid source (e.g., a set of hydrants, tanks, combinations thereof, etc.), and another end of the fluid manifold 112 delivers the fluid (e.g., water, foam mixtures, fire retardants, combinations thereof, etc.) to the multiple fire monitors 114.

In some arrangements, the fluid manifold 112 mainly extends horizontally between a back and a front of the firefighting vehicle body 110 (e.g., along the X-axis in FIGS. 1 through 6). Additionally, where the fluid manifold 112 ends at the front of the firefighting vehicle body 110, the fluid manifold 112 bends upwardly at a 90 degree angle to point vertically (e.g., along the Z-axis in FIGS. 1 through 6). Along these lines, the fluid manifold 112 flanges outwardly (e.g., along a horizontal X-Y plane) to enable attachment of other similarly flanged componentry.

The multiple fire monitors 114 are constructed and arranged to receive fluid from the fluid manifold 112 and output the fluid for rich and reliable firefighting operations. For example, one monitor 114 may aim a first high capacity fluid stream in one direction at a first burning target while another monitor 114 may aim another high capacity fluid stream in another direction at another burning target. As another example, one monitor 114 may aim a first high capacity fluid stream in one direction at a burning target while another monitor 114 sprays fluid over the firefighting robotic vehicle 100 to protect the vehicle 100 (e.g., as a fog or mist, in a wider dispersion pattern, etc.).

The fire monitor adaptor 116 is constructed and arranged to reside between the fluid manifold 112 and the multiple fire monitors 114, and convey fluid from the fluid manifold 112 to the multiple fire monitors 114. Along these lines, the fire monitor adaptor 116 may be physically supported at least in part by the fluid manifold 112. Alternatively or additionally, the fire monitor adaptor 116 may be physically supported at least in part by the robotic firefighting vehicle body 110 (e.g., via support scaffolding, beams, braces, hardware, combinations thereof, etc.).

In accordance with certain embodiments, the firefighting robotic vehicle 100 includes additional componentry to further optimize and/or enhance the firefighting capabilities of the vehicle 100. Such componentry may or may not be shown in the figures.

Along these lines, in some embodiments, the firefighting robotic vehicle 100 further includes multiple robotic valve apparatus 120 which control fluid delivery from the fire monitor adaptor 116 to the multiple fire monitors 114 (e.g., see FIG. 2). Such robotic valve apparatus 120 may be individually opened/closed via remote control to enable delivery through one or more of the multiple fire monitors 114. For example, all of the robotic valve apparatus 120 may be opened to enable all of the fire monitors 114 to output fluid at the same time.

As another example, suppose that the firefighting robotic vehicle 100 is moving closer to a set of burning targets (e.g., one or more burning targets). While the firefighting robotic vehicle 100 is still far away, one robotic valve apparatus 120 may be opened and another robotic valve apparatus 120 may be closed to enable more fluid pressure and greater fluid capacity through the opened robotic valve apparatus 120 to deliver fluid from a fire monitor 114 fed by the opened robotic valve apparatus 120 to reach a greater distance. When the firefighting robotic vehicle 100 have moved within closer range, the other robotic valve apparatus 120 may be opened to provide fluid from multiple fire monitors 114 (e.g., for multiple targets, for wider coverage, etc.).

Other componentry may be included as well. For example, the firefighting robotic vehicle 100 may include a panel or a protective plate which covers/insulates the fire monitor adaptor 116 to protect against fire/heat damage, foam concentrate tanks to create foam mixtures, lights, fans, sensors, and so on.

In some embodiments, the multiple fire monitors 114 and the fire monitor adaptor 116 perhaps along with other components such as the multiple robotic valve apparatus 120 form augmented fire monitor equipment 130 (see FIG. 2) which may be utilized in place of a single fire monitor. For example, the existing fire monitor of a conventional firefighting vehicle may be replaced with the augmented fire monitor equipment 130 to enable the conventional firefighting vehicle to address multiple targets.

Similarly, the augmented fire monitor equipment 130 of the firefighting robotic vehicle 100 may be replaced with a single firefighting monitor. Along these lines, there may be a situation in which the operator of the firefighting robotic vehicle 100 prefers using a single fire monitor and, to accommodate such a situation, the operator may simply remove the augmented fire monitor equipment 130 and replace it a single fire monitor.

During operation, a user may operate a control device to remotely control the firefighting robotic vehicle 100 from a safe distance. Along these lines, using the control device, the user may robotically drive the vehicle 100 toward a burning target while the vehicle is connected to a water source.

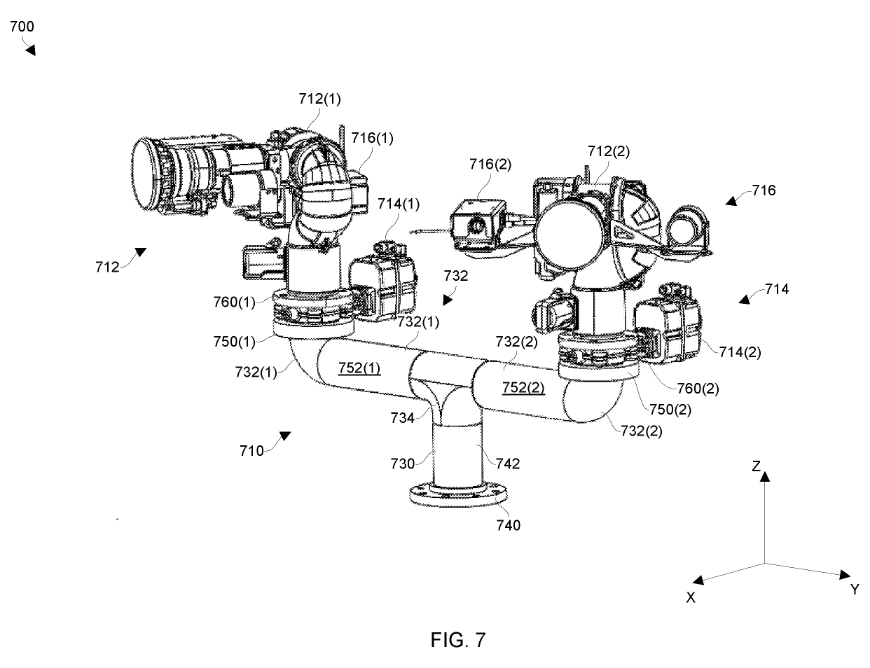

Additionally, using the control device, the user may robotically aim the multiple fire monitors at target and discharge water from the fire monitors. For example, the user may aim one fire monitor 114 in one direction at one target and another fire monitor 114 in a different direction at another target. Such targets may include separate fires, different sections of a burning area, a remote target and the vehicle 100 itself, combinations thereof, and so on. Further details will now be provided with reference to FIGS. 7 through 9.

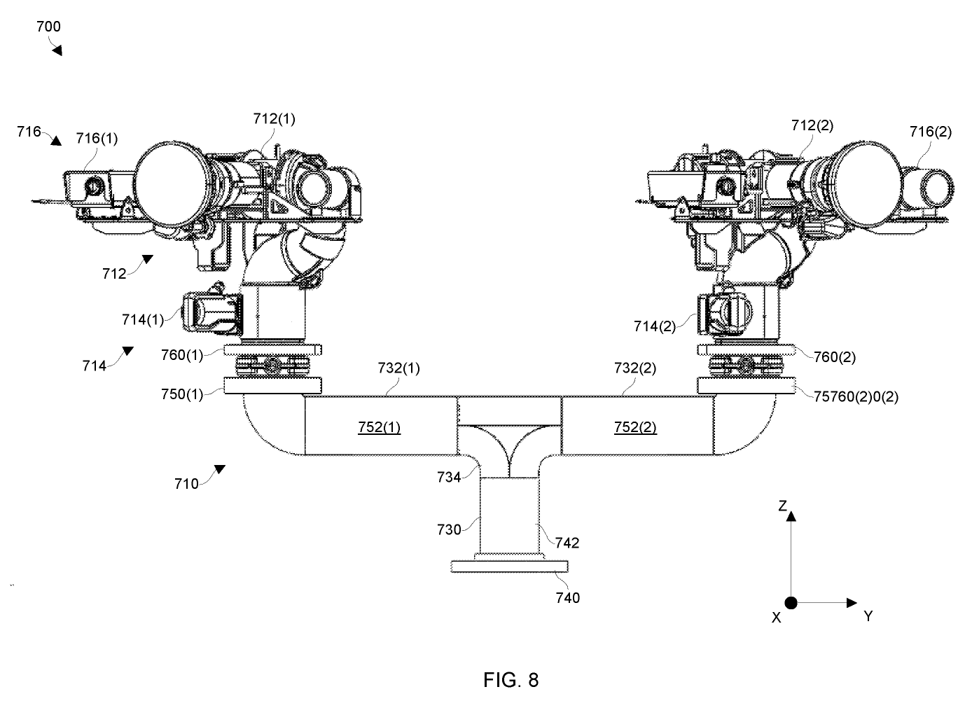

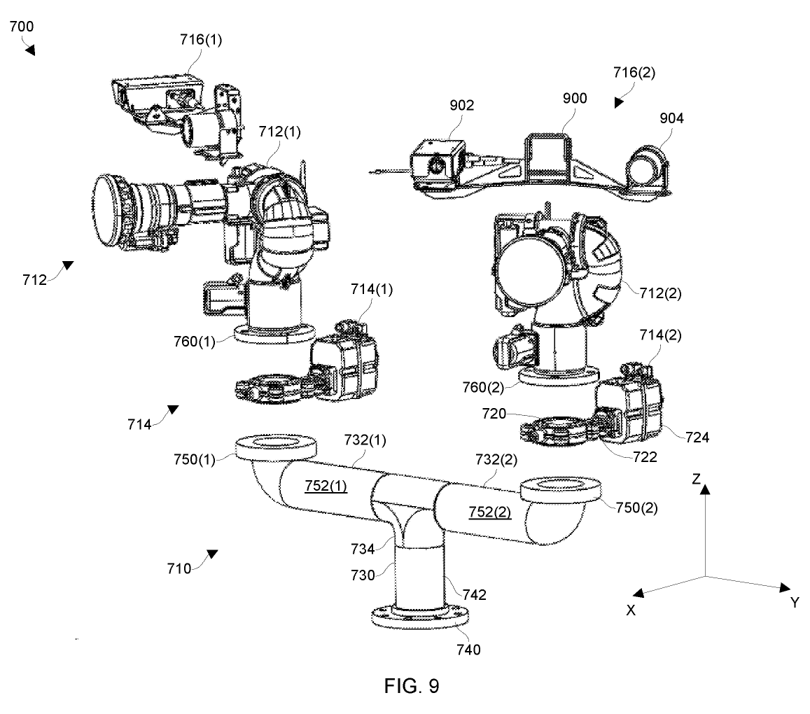

FIGS. 7 through 9 show details of a firefighting assembly 700 which is suitable for use as the augmented fire monitor equipment 130 in accordance with certain embodiments (also see FIG. 2). FIG. 7 is a perspective view of the firefighting assembly 700. FIG. 8 is a front view of the firefighting assembly 700. FIG. 9 is an exploded view of the firefighting assembly 700.

The firefighting assembly 700 includes an adaptor 710, fire monitors 712(1), 712(2) (collectively, fire monitors 712), valve mechanisms 714(1), 714(2) (collectively, valve mechanisms 714), and sensor equipment 716(1), 716(2) (collectively, sensor equipment 716).

The adaptor 710 is constructed and arranged to reside between a fluid manifold and the fire monitors 710, and convey fluid from the fluid manifold to the fire monitors 710. Such a fluid manifold may form a portion of a vehicle such as a landcraft, watercraft, hybrid vehicles, etc. enabling the multiple fire monitors 710 to provide fluid from the vehicle (e.g., see the fluid manifold 112 of the firefighting robotic vehicle 100 in FIGS. 1 through 6).

Along these lines, the adaptor 710 includes an input section 730, multiple output sections 732, and an intermediate section 734. The input section 730 is constructed and arranged to couple with the fluid manifold. Additionally, the multiple output sections 732 are constructed and arranged to couple with the fire monitors 712. Furthermore, the intermediate section 734 is interconnected between the input section 730 and the multiple output sections 732 and is constructed and arranged to convey fluid from the input section 730 to the multiple output sections 732 when the adaptor 710 couples with the fluid manifold and the fire monitors 712 and the fluid is provided into the input section 730 from the fluid manifold for delivery to the fire monitors 712.

The fire monitors 712 are constructed and arranged to direct fluid towards targets. Along these lines, a variety of fire monitors 712 are suitable for use such as those with smooth bore nozzles, those with fog nozzles, water curtain monitors, oscillating monitors, and so on. Moreover, in some arrangements, the firefighting assembly 700 is equipped with different types of fire monitors 712, e.g., the fire monitor 712(1) may include a smooth bore nozzle to deliver fluid over a long distance with accuracy while the fire monitor 712(2) may include a fog nozzle to enable delivery over a wider area or over the equipment that the firefighting assembly 700 attaches to (e.g., self-spraying). Alternatively, in some arrangements, the fire monitor 712(1) and the fire monitor 712(2) have the same nozzle type such as smooth bore nozzles to address multiple burning targets from a distance or fog nozzles to address burning areas at closer range, etc.

The valve mechanisms 714 are constructed and arranged to control release of fluid from the adaptor 710 to the fire monitors 712. Along these lines, the valve mechanism 714(1) independently controls fluid delivery to the first fire monitor 712(1), and the valve mechanism 714(2) independently controls fluid delivery to the second fire monitor 712(2). Accordingly, a valve mechanism 714 may include a dedicated valve 720, a dedicated actuator 722, a dedicated electronic controller 724, and so on (e.g., see FIG. 9).

In some arrangements, the valve mechanisms 714 are held in place (e.g., sandwiched) between the adaptor 710 and fire monitors 712 via fastening of the fire monitors 712 to the adaptor 710 (e.g., via hardware). In other arrangements, the valve mechanisms 714 fasten to the adaptor 710 (e.g., via hardware), and the fire monitors 712 then fasten to the valve mechanisms 714 and/or the adaptor 710 (e.g., via additional hardware).

The adaptor 710 is constructed and arranged to reside between a fluid manifold, which leads to a fluid source (e.g., to one or more hydrants, tanks, etc.), and the multiple fire monitors 712. Along these lines, the input section 730 of the adaptor 710 is constructed and arranged to couple with the fluid manifold. Along these lines, the input section 730 may include an input section flange 740 constructed and arranged to couple with a manifold flange of the fluid manifold (e.g., see FIGS. 1 through 6), and input section piping 742 that extends from the input section flange 740 to the intermediate section 734. Accordingly, when the adaptor 710 is attached to the fluid manifold, the input section piping 742 provides a straight fluid pathway contiguously from the fluid manifold to the intermediate section 734 (e.g., along the Z-axis in FIGS. 7 through 9).

The multiple output sections 732 are constructed and arranged to couple with the multiple fire monitors 712. Along these lines, the output section 732(1) may include an output section flange 750(1) and output section piping 752(2) that extends from the output section flange 750(1) to the intermediate section 734. Likewise, the output section 732(2) may include an output section flange 750(2) and output section piping 752(2) that extends from the output section flange 750(2) to the intermediate section 734, etc. Accordingly, the output sections 732 may provide 90 degree turns from the intermediate section 734 to respective fire monitors 714.

Additionally, the output section flange 750(1) is constructed and arranged to couple with a monitor flange 760(1) of the fire monitor 712(1). Similarly, the output section flange 750(2) is constructed and arranged to couple with a monitor flange 760(2) of the fire monitor 712(2).

It should be understood that the flanges 740, 750(1), and 750(2) may have standard interfaces (e.g., predefined dimensions, hole patterns for hardware, etc.) for mounting to various firefighting components. For example, if the manifold flange of the fluid manifold and the monitor flanges 760(1), 760(2) of the fire monitors 712(1), 712(2) have standard interfaces which enable the fire monitors 712(1), 712(2) to attach directly to manifold flanges and vice versa, the flanges 740, 750(1), and 750(2) may have matching standard interfaces for attachment compatibility, alignment, and so on (e.g., predefined dimensions, hole patterns for hardware, etc.).

In some arrangements, the inner diameter of the input section flange 740 and the input section 742 of the input section 730 is the same as the inner diameters of the output section flanges 750(1), 750(2) and the output section piping 752(1), 752(2) of the output sections 732. Along these lines, all of these features may have a common diameter (e.g., 3 inches, 4 inches, etc.).

In other arrangements, the inner diameter of the input section flange 740 and the input section 742 may be different from the inner diameters of the output section flanges 750(1), 750(2) and the output section piping 752(1), 752(2). Along these lines, the inner diameters of the output section flanges 750(1), 750(2) and the output section piping 752(1), 752(2) may be narrower than the inner diameter of the input section flange 740 and the input section 742. For example, the input section flange 740 and the input section 742 may have a 4 inch diameter, and the output section flanges 750(1), 750(2) and the output section piping 752(1), 752(2) may have 3 inch diameters, and so on.

The intermediate section 734 is interconnected between the input section 730 and the multiple output sections 732. The intermediate section 734 is constructed and arranged to convey fluid from the input section 730 to the multiple output sections 732 when the adaptor 710 couples with the fluid manifold and with the multiple fire monitors 712 and fluid is provided into the input section 730 from the fluid manifold for delivery to the multiple fire monitors 712.

In accordance with certain embodiments, the intermediate section 734 has a tree-like configuration (e.g., a “T” or “Y” formation). Along these lines, the input section 730 defines a main trunk, and the intermediate section branches out from the main trunk to the output sections 732.

In some arrangements, the input section flange 740 of the input section 730 extends outwardly from the input section piping 742 in a horizontal X-Y plane. Likewise, the output section flanges 750(1), 750(2) extend outwardly in horizontal X-Y planes. Such arrangements, orient the adaptor 710 and the fire monitors 712 at upright angles for optimized ranges of motion for effective fluid delivery.

Additionally, in some arrangements, the input section piping 742 of the input section 730 extends vertically to provide elevation to the fire monitors 712. Such arrangements are well suited for positioning one or more fire monitors 712 at a raised height which enables the fire monitors 712 target locations above obstructions (e.g., above debris in front of the firefighting assembly 700, above a vehicle section that would otherwise block or interfere with effective self-spraying, combinations thereof, etc.).

It should be appreciated that the sensor equipment 716 is optional. However, in some arrangements, fire monitors 712 are provisioned with respective sensor equipment 716. As shown in FIG. 9, the sensor equipment 716(2) for the fire monitor 712(2) includes a mount 900, a thermal camera 902, and an optical camera 904. Other sensors may be included with or substituted for the sensor equipment 716. With the fire monitors 712 being equipped with respective sensor equipment 716, a user may effectively operate the fire monitors 712 individually from a safe distance (e.g., via a controller and selecting using a switch, etc.).

Furthermore, in some arrangements, the adaptor 710 is formed of cast metallic material (e.g., aluminum, iron, various alloys, etc.). Such arrangements provide a combination of advantageous characteristics for strength, weight, manufacturability, installation, serviceability, and so on.

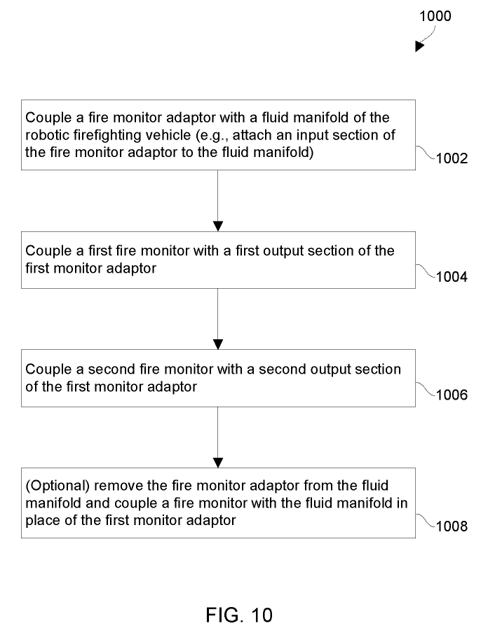

It should be understood that the adaptor 710 was described above as supporting two fire monitors 712 by way of example only. However, nothing precludes the adaptor 710 from supporting a number of fire monitors 712 that is different from two. For example, one or more additional output sections 732 may be connected with the intermediate section 734 to support a different number of fire monitors 712 such as three, four, and so on. Also, the various sections of the adaptor 710 (e.g., the output sections 732) may have different lengths, diameters, heights, directions, and so on to provide further flexibility, to handle different scenarios, and so on. Moreover, with properly attached valve mechanisms 714, one or more output sections 732 may simply be terminated by one or more respective valve mechanisms 714 alleviating any need to attach fire monitors 712 on all of the output sections 732 when using the adaptor 710. Further details will now be provided with reference to FIG. 10.

FIG. 10 is a flowchart of an example procedure 1000 which enables an installer to configure a robotic firefighting vehicle. A suitable robotic firefighting vehicle 100 is shown in FIGS. 1 through 6.

At 1002, the installer couples a fire monitor adaptor with a fluid manifold of the robotic firefighting vehicle. For example, an input section of the adaptor may attach to the fluid manifold (e.g., see FIGS. 1 and 7).

At 1004, the installer couples a first fire monitor with a first output section of the fire monitor adaptor. In some situations, the installer disposes a portion of a valve mechanism 712(1) (e.g., see FIG. 7) between the fire monitor adaptor and the first fire monitor. Such a valve mechanism 712(1) enables an operator to remotely open/close the valve mechanism 712(1) to control delivery of fluid from the adaptor to the first fire monitor from a safe distance.

At 1006, the installer couples a second fire monitor with a second output section of the fire monitor adaptor. Again, in some situations, the installer disposes a portion of a valve mechanism 712(2) (e.g., see FIG. 7) between the fire monitor adaptor and the second fire monitor. Such a valve mechanism 712(2) enables an operator to remotely open/close the valve mechanism 712(2) to control delivery of fluid from the adaptor to the second fire monitor from a safe distance.

At this point, the robotic firefighting vehicle is configured to address multiple targets. For example, the robotic firefighting vehicle may deliver fluid to a wider section of a burning area, to multiple independent burning targets, to a burning target and to the robotic firefighting vehicle at the same time, and so on.

Optionally, at 1008, the installer may further configure the robotic firefighting vehicle by replacing the equipment with a single fire monitor. Here, the installer removes the fire monitor adaptor from the fluid manifold, and couples the single fire monitor with the fluid manifold of the robotic firefighting vehicle in place of the fire monitor adaptor.

As described above, a fire monitor adaptor supports multiple fire monitors. For example, such a fire monitor adaptor may couple between a firefighting vehicle’s fluid manifold and multiple fire monitors to enable the fluid manifold to supply fluid to the multiple fire monitors. Along these lines, one fire monitor can be directed in a manner that protects the firefighting vehicle while another other fire monitor focuses on a burning target. Accordingly, there is no need for a water sprayer network that would otherwise increase plumbing complexity, potentially intrude or interfere with other equipment on the vehicle, be unusable for applying water to a burning target at a distance, and so on. Rather, the fire monitor adaptor may easily couple with the same fluid manifold that would normally support a single fire monitor and thus alleviate having to modify the vehicle’s internal plumbing.

Moreover, if the firefighting vehicle does not require fire monitor protection, one fire monitor may direct fluid from the fire monitor adaptor toward a first burning target while another fire monitor may direct fluid from the fire monitor adaptor toward a second burning target (e.g., to provide wider coverage of a burning area, to address two independent fires, to increase capacity to a single burning target, etc.). Accordingly, the fire monitor adaptor offers great flexibility to the firefighting vehicle such as enabling the firefighting vehicle to effectively address multiple targets.

While various embodiments of the present disclosure have been particularly shown and described, it will be understood by those skilled in the art that various changes in form and details may be made therein without departing from the spirit and scope of the present disclosure. Such modifications and enhancements are intended to belong to various embodiments of the disclosure.

For example, the above-mentioned adaptors were described as being utilized on a robotic firefighting vehicle. However, the adaptors may be utilized in other scenarios as well. Suitable uses include manned fire trucks, specialized fluid deployment vehicles, watercraft, fixed fluid deliver applications, and any other situations in which it would be advantageous to apply fluid to multiple targets.

It should be appreciated that prior methods to solve a problem of having multiple fires when there is only one monitor on a robot would have been to bring in a second robot with a second monitor. If there wasn’t a second robot available then someone would have had to use a fire truck, but it may be very limiting where a truck is able to get to and reach with the monitor on it. Also, a firefighter could go in with a hand line to fight the fire but depending on the circumstances this may be dangerous for the person. However, in accordance with certain embodiments disclosed herein, a dual monitor setup allows for a single robot to cover multiple areas at once.

It should be further appreciated that, without the addition of a second monitor some alternatives may include choosing which fire is higher priority and attack that one, then move on to next highest and so on, or utilizing a second vehicle with a monitor for the same dual attack capabilities, or a firefighter might have to use a hand line or other equipment to attack a second source. Unfortunately, such alternatives have deficiencies such as inefficient use of resources, impracticality, unreasonable riskiness, and so on.

In accordance with certain embodiments, there is a multiple monitor configuration which enables application of fluid to multiple targets. Such improvements provide great utility generally in the field of firefighting, and may relate specifically to firefighting robotics.

Along these lines, certain embodiments enable having two monitors to allow for a user to direct fluid (e.g., water flow, foam mixtures, etc.) to two separate areas at the same time. A monitor may now be raised up allow for fluid directed towards the rear of the vehicle where it may have been obstructed before.

In accordance with certain embodiments, there is now a second monitor for independent or combined control. One or more monitors may now be raised up to allow for the monitors to spray behind the robot (e.g., increased coverage). Multiple monitors allow for capability to more comprehensively address fire and provide secondary fire prevention.

In accordance with certain embodiments, an additional monitor may be added to a firefighting robot. With only a single monitor, a user is limited to only being able to provide water to a single source of fire. It is not uncommon however to have a scene where there can be a single large fire that covers a wide area or have two or more independent fires. Having multiple monitors allows the user to direct one water source in one area and the other water source at a different area, extending the coverage ability of the robot.

In certain embodiments, the robot’s manifold is setup in a way that has a flange on the front that was to bolt a monitor directly to the flange. Such embodiments may use the same flange to bolt together a section of welded pipe with a flange that mates to the manifold flange, on the other end of the pipe is a tee that splits the water source. On the upper ends of the tee there is a section of pipe with a 90° elbow facing upwards on each and on the ends of the elbow there is a flange in which we are able to mount a monitor.

Certain improvements disclosed herein are appropriate for anything in the firefighting industry, fire trucks with monitors on them, fire boats with monitors, etc. Monitors are also used for decontamination spray down devices used on larger ships. Monitors are also used for dust control in some applications. Anywhere that a monitor is being used may benefit from a dual monitor setup to replace a single unit, doubling the area that can be covered at a single time.

The description herein provides examples for the purposes of understanding and is not intended to limit the invention or the application and uses of the same. Furthermore, there is no intention to be bound by any expressed or implied theory presented herein.

Directional references such as “top,” “bottom,” “left,” “right,” “above,” “below,” and so forth, unless otherwise stated, are not intended to require any preferred orientation and are made with reference to the orientation of the corresponding figure or figures for purposes of illustration.

It will be appreciated that the steps of various processes described herein are non-limiting examples of suitable processes according to embodiments and are for the purposes of illustration. Systems and devices according to embodiments herein may use any suitable processes including those that omit steps described above, perform those steps and similar steps in different orders, and the like. It will also be appreciated that well-known features may be omitted for clarity.

Certain embodiments are directed to a method of configuring a robotic firefighting vehicle. The method includes coupling a fire monitor adaptor with a fluid manifold of the robotic firefighting vehicle. The fire monitor adaptor includes:
(i) an input section constructed and arranged to couple with the fluid manifold,
(ii) multiple output sections constructed and arranged to couple with multiple fire monitors, and
(iii) an intermediate section interconnected between the input section and the multiple output sections, the intermediate section being constructed and arranged to convey fluid from the input section to the multiple output sections.

The method further includes coupling a first fire monitor with a first output section of the fire monitor adaptor, and coupling a second fire monitor with a second output section of the fire monitor adaptor.

In some arrangements, the method further includes removing the fire monitor adaptor from the fluid manifold, and coupling a fire monitor with the fluid manifold of the robotic firefighting vehicle in place of the fire monitor adaptor.

Additional embodiments are directed to a fire monitor adaptor which includes an input section constructed and arranged to couple with a fluid manifold. The fire monitor adaptor further includes multiple output sections constructed and arranged to couple with multiple fire monitors. The fire monitor adaptor further includes an intermediate section interconnected between the input section and the multiple output sections. The intermediate section is constructed and arranged to convey fluid from the input section to the multiple output sections when the fire monitor adaptor couples with the fluid manifold and the multiple fire monitors and the fluid is provided into the input section from the fluid manifold for delivery to the multiple fire monitors.

Further embodiments are directed to a robotic firefighting vehicle which includes a robotic firefighting vehicle body, a fluid manifold supported by the robotic firefighting vehicle body, multiple fire monitors, and a fire monitor adaptor. The fire monitor adaptor includes:
(i) an input section constructed and arranged to couple with the fluid manifold,
(ii) multiple output sections constructed and arranged to couple with the multiple fire monitors, and
(iii) an intermediate section interconnected between the input section and the multiple output sections, the intermediate section being constructed and arranged to convey fluid from the input section to the multiple output sections when the fire monitor adaptor couples with the fluid manifold and the multiple fire monitors and the fluid is provided into the input section from the fluid manifold for delivery to the multiple fire monitors.

In accordance with one or more embodiments, the fire monitor adaptor has a branching formation in which the input section defines a main trunk, and the intermediate section defines fluid pathways which branch out from the main trunk to the multiple output sections.

In accordance with one or more embodiments, the input section defines a first inner diameter and the multiple output sections define second inner diameters which are narrower than the first inner diameter.

In accordance with one or more embodiments, the input section includes an input section flange constructed and arranged to couple with a manifold flange of the fluid manifold, and input section piping that extends from the input section flange to the intermediate section. Additionally, the multiple output sections include:
(i) a first output section including a first output section flange constructed and arranged to couple with a first monitor flange of a first fire monitor, and first output section piping that extends from the first output section flange to the intermediate section; and
(ii) a second output section including a second output section flange constructed and arranged to couple with a second monitor flange of a second fire monitor, and second output section piping that extends from the second output section flange to the intermediate section.

In accordance with one or more embodiments, the input section flange protrudes from the input section piping along an input section flange plane. Additionally, the first output section flange protrudes from the first output section piping along a first output section flange plane that is parallel to the input section flange plane. Furthermore, the second output section flange protrudes from the second output section piping along a second output section flange plane that is parallel to the input section flange plane.

In accordance with one or more embodiments, the input section piping, the first output section piping and the second output section piping extend along vertical axes when the input section of the fire monitor adaptor couples with the fluid manifold.

In accordance with one or more embodiments, the input section flange, the first output section flange and the second output section flange extend along horizontal planes when the input section of the fire monitor adaptor couples with the fluid manifold.

In accordance with one or more embodiments, the input section piping provides a straight fluid pathway contiguously from the fluid manifold to the intermediate section.

In accordance with one or more embodiments, the first output section piping provides a first 90 degree turn from the intermediate section to the first fire monitor. Additionally, the second output section piping provides a second 90 degree turn from the intermediate section to the second fire monitor.

In accordance with one or more embodiments, the first fire monitor includes a smooth bore nozzle to provide a solid stream. Additionally, the second fire monitor includes a fog nozzle to provide a fog pattern which is different from the solid stream.

In accordance with one or more embodiments, the adaptor further includes multiple remotely controllable valves coupled with the multiple output sections of the fire monitor adaptor and the multiple fire monitors.

In accordance with one or more embodiments, the multiple fire monitors includes a first fire monitor and a second fire monitor. Additionally, the multiple output sections of the fire monitor adaptor includes a first output section and a second output section. Furthermore, the multiple remotely controllable valves includes a first remotely controllable valve disposed between the first fire monitor and the first output section, and a second remotely controllable valve disposed between the second fire monitor and the second output section.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Also, the foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematics and component features shown in the figures depict one exemplary arrangement of elements, additional intervening elements, devices, features, or components may be present in one or more other embodiments of the depicted subject matter.

Those skilled in the art will therefore understand that various changes in form and detail may be made to the embodiments disclosed herein without departing from the scope of the following claims.

What is claimed is:

1. A robotic firefighting vehicle, comprising:
a robotic firefighting vehicle body;
a fluid manifold supported by the robotic firefighting vehicle body;
multiple fire monitors; and
a fire monitor adaptor which includes:
an input section constructed and arranged to couple with the fluid manifold,
multiple output sections constructed and arranged to couple with the multiple fire monitors, and
an intermediate section interconnected between the input section and the multiple output sections, the intermediate section being constructed and arranged to convey fluid from the input section to the multiple output sections when the fire monitor adaptor couples with the fluid manifold and the multiple fire monitors and the fluid is provided into the input section from the fluid manifold for delivery to the multiple fire monitors.

2. The robotic firefighting vehicle of claim 1, wherein the fire monitor adaptor has a branching formation in which the input section defines a main trunk, and the intermediate section defines fluid pathways which branch out from the main trunk to the multiple output sections.

3. The robotic firefighting vehicle of claim 1, wherein the input section defines a first inner diameter and the multiple output sections define second inner diameters which are narrower than the first inner diameter.

4. The robotic firefighting vehicle of claim 1, wherein the input section includes an input section flange constructed and arranged to couple with a manifold flange of the fluid manifold, and input section piping that extends from the input section flange to the intermediate section;
wherein the multiple output sections include:
a first output section including a first output section flange constructed and arranged to couple with a first monitor flange of a first fire monitor, and first output section piping that extends from the first output section flange to the intermediate section; and
a second output section including a second output section flange constructed and arranged to couple with a second monitor flange of a second fire monitor, and second output section piping that extends from the second output section flange to the intermediate section.

5. The robotic firefighting vehicle of claim 4, wherein the input section flange protrudes from the input section piping along an input section flange plane;
wherein the first output section flange protrudes from the first output section piping along a first output section flange plane that is parallel to the input section flange plane; and
wherein the second output section flange protrudes from the second output section piping along a second output section flange plane that is parallel to the input section flange plane.

6. The robotic firefighting vehicle of claim 4, wherein the input section piping, the first output section piping and the second output section piping extend along vertical axes when the input section of the fire monitor adaptor couples with the fluid manifold.

7. The robotic firefighting vehicle of claim 4, wherein the input section flange, the first output section flange and the second output section flange extend along horizontal planes when the input section of the fire monitor adaptor couples with the fluid manifold.

8. The robotic firefighting vehicle of claim 4, wherein the input section piping provides a straight fluid pathway contiguously from the fluid manifold to the intermediate section.

9. The robotic firefighting vehicle of claim 4, wherein the first output section piping provides a first 90 degree turn from the intermediate section to the first fire monitor; and
wherein the second output section piping provides a second 90 degree turn from the intermediate section to the second fire monitor.

10. The robotic firefighting vehicle of claim 4, wherein the first fire monitor includes a smooth bore nozzle to provide a solid stream; and
wherein the second fire monitor includes a fog nozzle to provide a fog pattern which is different from the solid stream.

11. The robotic firefighting vehicle of claim 1, further comprising:
multiple remotely controllable valves coupled with the multiple output sections of the fire monitor adaptor and the multiple fire monitors.

12. The robotic firefighting vehicle of claim 11 wherein the multiple fire monitors includes a first fire monitor and a second fire monitor;
wherein the multiple output sections of the fire monitor adaptor includes a first output section and a second output section; and
wherein the multiple remotely controllable valves includes a first remotely controllable valve disposed between the first fire monitor and the first output section, and a second remotely controllable valve disposed between the second fire monitor and the second output section.

13. Fire monitor adaptor, comprising:
an input section constructed and arranged to couple with a fluid manifold;
multiple output sections constructed and arranged to couple with multiple fire monitors; and
an intermediate section interconnected between the input section and the multiple output sections, the intermediate section being constructed and arranged to convey fluid from the input section to the multiple output sections when the fire monitor adaptor couples with the fluid manifold and the multiple fire monitors and the fluid is provided into the input section from the fluid manifold for delivery to the multiple fire monitors.

14. The fire monitor adaptor of claim 13, wherein the fire monitor adaptor has a branching formation in which the input section defines a main trunk, and the intermediate section defines fluid pathways which branch out from the main trunk to the multiple output sections.

15. The fire monitor adaptor of claim 14, wherein the input section defines a first inner diameter and the multiple output sections define second inner diameters which are narrower than the first inner diameter.

16. The fire monitor adaptor of claim 15, wherein the input section includes an input section flange constructed and arranged to couple with a manifold flange of the fluid manifold, and input section piping that extends from the input section flange to the intermediate section;
wherein the multiple output sections include:
a first output section including a first output section flange constructed and arranged to couple with a first monitor flange of a first monitor, and first output section piping that extends from the first output section flange to the intermediate section; and
a second output section including a second output section flange constructed and arranged to couple with a second monitor flange of a second monitor, and second output section piping that extends from the second output section flange to the intermediate section.

17. The fire monitor adaptor of claim 16, wherein the input section flange protrudes from the input section piping along an input section flange plane;
wherein the first output section flange protrudes from the first output section piping along a first output section flange plane that is parallel to the input section flange plane; and
wherein the second output section flange protrudes from the second output section piping along a second output section flange plane that is parallel to the input section flange plane.

18. The fire monitor adaptor of claim 17, wherein the input section piping provides a straight fluid pathway contiguously from the input section flange to the intermediate section;
wherein the first output section piping provides a first 90 degree turn from the intermediate section to the first output section flange; and
wherein the second output section piping provides a second 90 degree turn from the intermediate section to the second output section flange.

19. A method of configuring a robotic firefighting vehicle, the method comprising:
coupling a fire monitor adaptor with a fluid manifold of the robotic firefighting vehicle, the fire monitor adaptor including:
an input section constructed and arranged to couple with the fluid manifold,
multiple output sections constructed and arranged to couple with multiple fire monitors, and
an intermediate section interconnected between the input section and the multiple output sections, the intermediate section being constructed and arranged to convey fluid from the input section to the multiple output sections;
coupling a first fire monitor with a first output section of the fire monitor adaptor; and
coupling a second fire monitor with a second output section of the fire monitor adaptor.

20. The method of claim 19, further comprising:
removing the fire monitor adaptor from the fluid manifold; and
coupling a fire monitor with the fluid manifold of the robotic firefighting vehicle in place of the fire monitor adaptor.
